(19) United States
(12) Patent Application Publication
(10) Pub. No.: US 2008/0184131 A1
(43) Pub. Date: Jul. 31, 2008

(54) Method for providing an asset criticality tool

(75) Inventors: Arthur J. Stack, San Diego, CA (US); Paul Cameron, San Diego, CA (US); Gregory V. Gouzev, San Diego, CA (US)

Correspondence Address: CATERPILLAR/FINNEGAN, HENDERSON, L.L.P., 901 New York Avenue, NW, WASHINGTON, DC, 20001-4413, US

(73) Assignee: Solar Turbines Inc.

(21) Appl. No.: 11/700,192

(22) Filed: Jan. 31, 2007

(51) Int. Cl. G06F 3/00

(52) U.S. Cl. 715/747; 715/771

(57) ABSTRACT

A computer system for a asset criticality system is provided. The computer system has a platform, at least one input device, and a central processing unit in communication with the platform and the at least one input device. The central processing unit is configured to receive project information from a user, asset population information about a project, and determine a plurality of available assets according to the received information. The central processing unit is also configured to generate asset information for the user based on the determined plurality of available assets and to provide at least one customized background display based on the received project and asset population information, and generated asset information. The central processing unit is further configured to enable the user to populate a customized background display by selectively adding individual assets and to individually rate the populated assets according to their criticality.

### TECHNICAL FIELD

The present disclosure is directed to the field of industrial assets and, more particularly, to a tool for determining the criticality of industrial assets.

### BACKGROUND

Machinery management has been increasing in both cost and business complexity over the past few decades. In response, customers and machinery providers have been seeking ways to improve understanding of machinery management including, for example, future scenario and logistics planning. Such knowledge is necessary to make informed support decisions. While a customer has particular equipment needs, the ability of the customer to get involved and take an active role in machinery management decisions depends on the degree of knowledge or information possessed by the particular individual making the decision.

Machinery management decisions are usually made by equipment providers or customers during a logistics and worksite planning process. The process of decision making in machinery management requires knowledge about equipment, including design and application, and logistics, including supplier chains, inventory, and scheduling. By considering these aspects of machinery management, a customer or provider may make an informed decision regarding worksite planning. However, one customer's particular needs may be different than another's, even while employing similar equipment or while working in the same industry. Furthermore, different customers may have different degrees of prior knowledge, as well as experience in previous projects. Without an appropriate tool, the process of planning a particular work setting, including different machinery, may be a time-consuming experience.

One tool that has been developed for providing asset criticality information is described in U.S. Patent Publication No. 2006/0241907 (the '907 publication) published to Armstrong et al. on Oct. 26, 2006. The '907 publication describes a method and a system for monitoring an entity within a process plant. The process described in the '907 publication includes collecting data associated with the status of the entity within the process plant. The process also includes collecting criticality data relating to the importance of the entity. The process utilizes the entity status data and the criticality data to perform a function within the process plant, such as monitoring, diagnostics, and maintenance functions

Although the method of the '907 publication may provide a process for monitoring assets within a process plant based on criticality of the assets, it may only be useful to existing systems and processes. In particular, it may not allow a particular customer or user to visualize the working environment during a planning phase of a project, where the exact assets that will be utilized in the project are not yet known. Similarly, the process described in the '907 publication does not consider different possible scenarios, the geographic area where the project might be located, or how the assets might be incorporated into the working environment according to a user's particular needs. The '907 publication also does not provide a visual display of these possible scenarios.

The present invention is directed to overcoming the one or more problems or disadvantages associated with the prior art.

### SUMMARY OF THE INVENTION

In accordance with one aspect, the present disclosure is directed toward a computer readable medium, tangibly embodied, including instructions for receiving project information about a user, asset population information from a project, and for determining a plurality of available assets according to the received information. The medium includes instructions for generating asset information for the user based on the determined plurality of available assets and for providing at least one customized background display based on the received project and asset population information, and generated asset information. The medium further includes instructions to enable the user to populate the customized background display by selectively adding individual assets. The medium also includes instructions for enabling the user to individually rate the populated assets according to their criticality.

According to another aspect, the present disclosure is directed toward a method for assessing the criticality of an asset. The method includes receiving project information from a user and for receiving asset population information about a project. The method also includes determining a plurality of available assets according to the received information. The method includes generating asset information for the user based on the determined plurality of assets and providing at least one customized background display based on the received project and asset information, and generated asset information. The method further includes enabling the user to populate the customized background display by selectively adding asset and to individually rate the populated assets according to their criticality.

### BRIEF DESCRIPTION OF THE DRAWINGS

FIG. 1 is a block illustration of an exemplary disclosed asset criticality computer system;

FIG. 2 is a schematic illustration of a database included in the disclosed asset criticality computer system of FIG. 1;

FIG. 3 is a schematic illustration of an exemplary browser associated with the asset criticality computer system of FIG. 1; and

FIG. 4 is a flowchart illustration of an exemplary disclosed method of operating the asset criticality computer system of FIG. 1.

### DETAILED DESCRIPTION

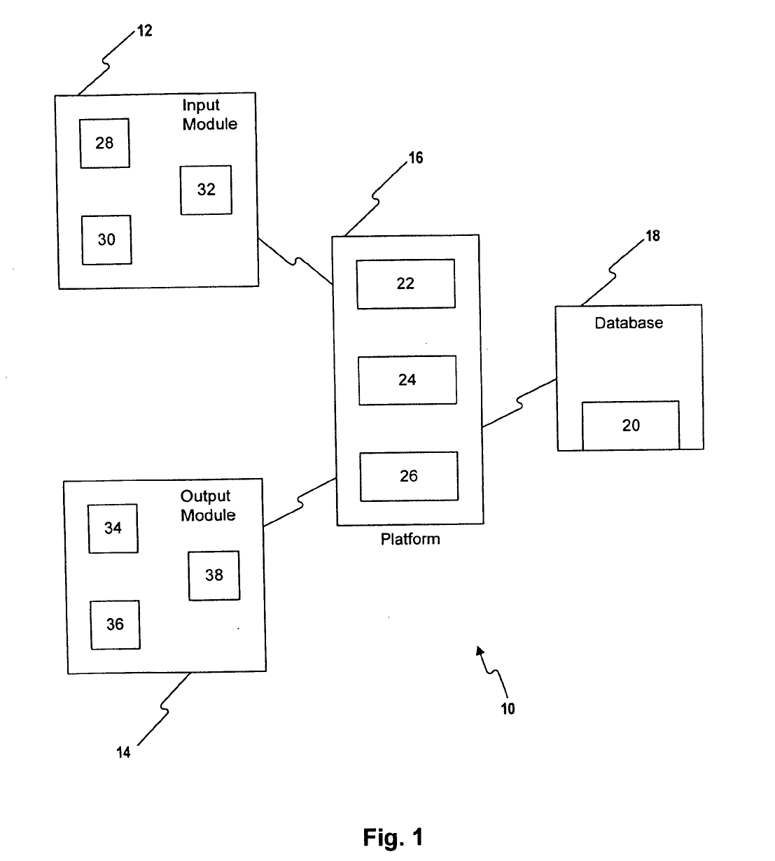

FIG. 1 illustrates an asset criticality system 10. System 10 may include an input module 12, an output module 14, and a computing platform 16. Computing platform 16 may include or may be otherwise operatively coupled to a database 18, which may be stored in a memory 20. Database 18 may include more than one database or another type of electronic repository. Computing platform 16 may include the necessary functionality and computing capabilities to implement asset criticality strategies through input module 12 and access, read, and write to database 18.

The results of data received from a user may be provided as output from computing platform 16 to output module 14 for printed display, viewing, and/or further communication to other system devices. Such output may include, for example, information packages, performance estimates and results, or asset information obtained from the asset criticality system for the user's reference. Output from computing platform 16 can also be provided to database 18, which may be utilized as a storage device for asset criticality information from customers or providers.

In the embodiment of FIG. 1, computing platform 16 may include a personal computer (PC) or mainframe computer configured to perform various functions and operations. Computing platform 16 may be implemented, for example, by a general purpose computer selectively activated or configured by a computer program stored in memory of the computer, or may be a specially constructed computing platform for carrying out the features and operations of asset criticality system 10. Computing platform 16 may also be implemented or provided with a wide variety of components or subsystems including, for example, one or more of the following: a processor 22, a co-processor 24, a register 26, and/or other data processing devices and subsystems. Computing platform 16 may also communicate or transfer asset criticality and machine management strategies or estimates, and feedback provided by users to input module 12 and/or from output module 14 through the use of direct connections or other communication links, as illustrated in FIG. 1. In an exemplary embodiment, a firewall may prevent access to the computer platform 16 by unauthorized outside entities. It is further contemplated that computing platform 16 may require user authentication, such as password verification, in order to prevent unauthorized users from gaining access to asset criticality information from a particular customer or provider.

It is further contemplated that communication between computing platform 16 and input and output modules 12, 14 can be achieved through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, computing platform 16 may be located in the same location or at a location geographically remote from input and/or output modules 12, 14.

Input module 12 may include a wide variety of devices to receive and/or provide the data as input to computing platform 16. As illustrated in FIG. 1, input module 12 may include an input device 28, a storage device 30, and/or a network interface 32. Input device 28 may include a keyboard, mouse, touchscreen, disk drive, video camera, magnetic card reader, or any other suitable input device for providing customer, employee, or member data to computing platform 16. Memory 20 may be implemented with various forms of memory or storage devices, such as read-only memory (ROM) devices and random access memory (RAM) devices. Storage device 30 may include a memory tape or disk drive for reading and providing data as input to computing platform 16. Network interface 32 may receive data over a network (such as a LAN, WAN, intranet or the Internet) and provide the same data as input to computing platform 16. For example, network interface 32 may be connected to a public or private database for the purpose of receiving information about users, such as customers or machinery providers, from computing platform 16.

Output module 14 may include a display 34, a printer device 36, and/or a network interface 38 for receiving the results provided as output from computing platform 16. As indicated above, the output from computing platform 16 may include one or more information packages, performance estimates and results, or asset information obtained from the asset criticality system 10 for the user's reference. The output from computing platform 16 may be displayed or viewed through display 34 (such as a CRT or LCD) and printer device 36. Network interface 38 may also facilitate the communication of the output from computing platform 16 over a network (such as a LAN, WAN, intranet or the Internet) to remote locations for further analysis, viewing or storing.

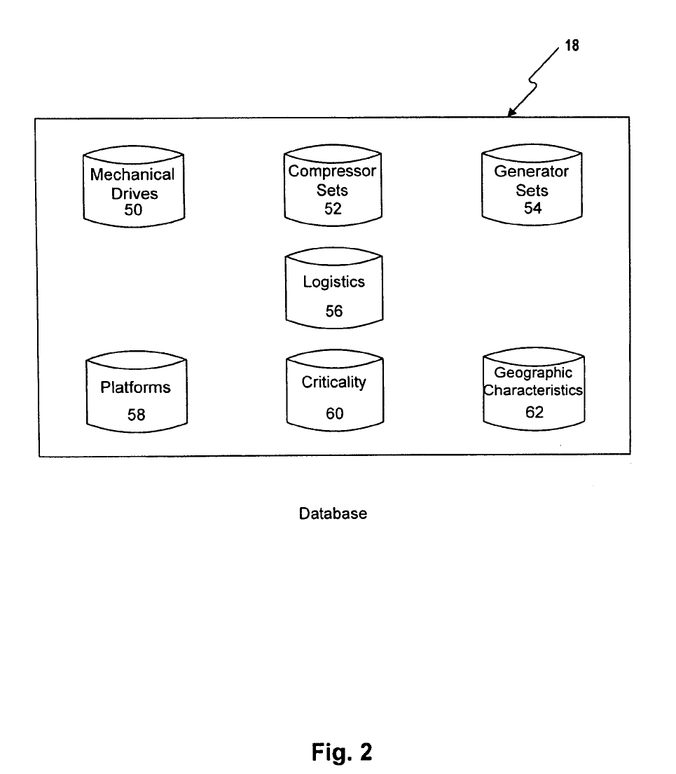

Asset criticality information applicable to customers or providers may be stored in memory 20 of database 18. FIG. 2 illustrates one embodiment of database 18, which may include asset-related information for a population of customers or machinery providers. Database 18 may also include data relevant to the population of customers or providers as a whole and/or selected segments of the population. Database 18 may further include individual asset-related data directed to individual customers or providers. Such individual data may include various information that may impact or otherwise relate to different aspects of machinery management or asset criticality.

For example, database 18 may include equipment related information such as mechanical drive information 50, compressor set information 52, and generator set information 54. All of this information may be furnished by the customer or machinery provider. Mechanical drive information 50 may include types of mechanical drives available in the asset criticality tool. Compressor set information 52 may include details regarding the compressor sets available in the asset criticality system 10. Generator set information 54 may include information detailing available generator sets in the asset criticality system 10.

Database 18 may also include worksite information, such as information relating to logistics 56. Worksite logistics information 56 may include, for example, information about how particular activities may be incorporated in the asset criticality system 10. For example, worksite logistics information 56 may include information regarding operation of commercial marine-based machine; aircraft; land-based vehicles such as buses, trucks, cranes, earth moving equipment, mining machines, backhoes, material handling equipment, farming equipment, and any type of movable machine that operates in a work environment. Worksite logistics information 56 may also include information associated with the operation of non-commercial vehicle such as passenger cars, vans, and other vehicles. Examples of worksite logistics information 56 may include a number of machines or equipment associated with a particular worksite. Worksite logistics information 56 may also include information indicating a number of employees needed at a worksite during a predetermined time period or in order to perform a certain function.

Database 18 may additionally information relating to work platforms 58. Work platform information 58 may include, for example, information about different facilities available at a particular worksite. Exemplary types of facilities may include off-shore oil drilling platforms and stationery land-based buildings.

Database 18 may further include asset criticality information 60 assigned or otherwise programmed by a user. Asset criticality information 58 may include ratings, such as high, medium, or low. The assigned rating of criticality may be based on the contribution that the particular asset or package of assets makes to the overall production and operation at the facility. Asset criticality information 60 may also include a default rating for a given asset, in case a user or customer does not select a high, medium, or low rating.

Asset criticality information 60 may be graphically represented, such as with a particular color or highlight indicative of the assigned asset criticality. For example, a high criticality rating may be associated with a red color and assigned to equipment with the greatest importance. Downtime involving these assets may cause significant impact to production, and little or no redundant equipment may be available for highly critical assets. A medium criticality rating may be associated with yellow and given to assets with average importance. A medium criticality rating may also indicate some redundant capacity or the existence of redundant equipment in case of asset failure. Unplanned downtime for equipment rated as having medium criticality may cause sizeable adverse effects, including, for example, additional manufacturing cost. A low criticality rating may be associated with green and given to equipment with low production volumes or with full redundant capacity. Unplanned downtime of low criticality assets may cause few adverse effects.

A default criticality rating may not be associated with a particular color. The default rating may instead be associated with prior criticality ratings assigned to similar equipment on prior occasions for a particular customer or worksite. Alternatively, the default criticality rating color may be specified by the asset criticality system 10 and remain the same for different applications.

Database 18 may also include geographic characteristic information 62. It is contemplated that geographic characteristic information 62 may include sample graphic illustrations that recreate geographic characteristics of particular worksite locations. For example, geographic characteristics information 62 may include depictions of land, sea, cities, or combinations thereof. Geographic characteristic information 62 may further provide a user with a graphic representation, such as a table or map illustrating how several platforms, mechanical drives, compressor sets, generator sets, and logistics equipment are positioned with respect to the recreated geographic characteristics. Geographic characteristic information 62 may further include terms and information applied by a customer or machinery provider to particular worksite characteristics. In one example, geographic characteristics information 62 may educate a user that a particular off-shore oil drilling platform is located at about 4 miles from the closest heliport. This information may be used by a customer or machinery provider in determining, for example, turnaround times for air freight between the platform and the heliport. This information may be defined by and dependent upon the selected geographical area and its particular characteristics, as included in geographic information 62.

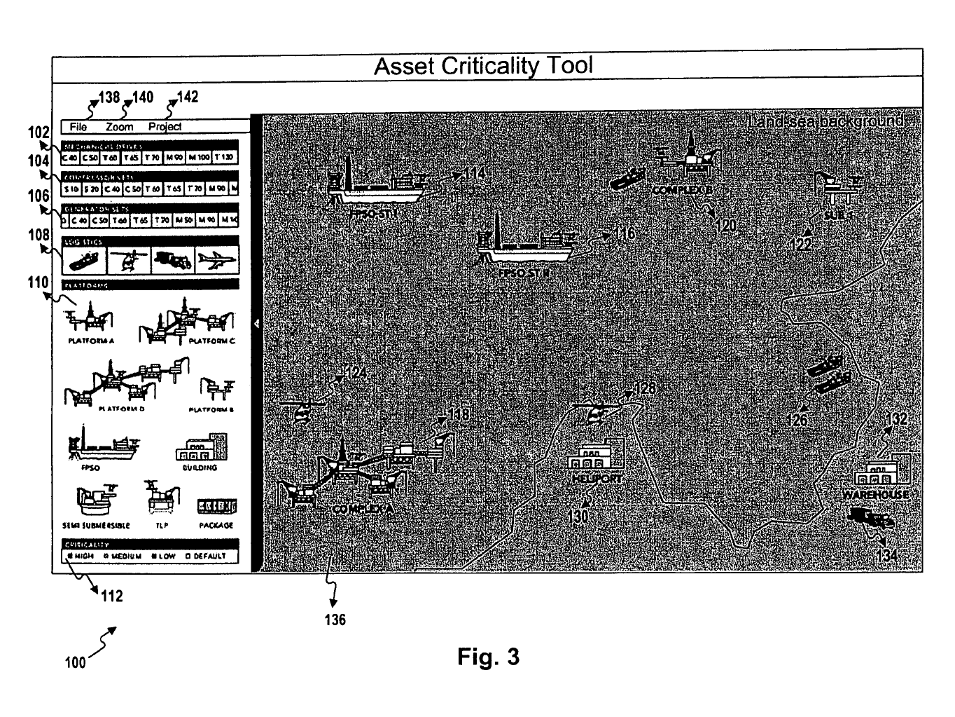

As illustrated in FIG. 3, system 10 may display various types of information, downloaded or otherwise gathered from one or more sources. For example, information from database 18 may be accessed and viewed via an exemplary browser 100. Browser 100 may include equipment information (e.g., mechanical drive information, compressor set information, generator set information, etc.), logistics information, facility information, criticality information, and/or geographic characteristics information, which may all be stored within database 18.

System 10 may develop and provide tailored information packages and/or tailored scenarios to users who are determined to share a particular set of work site conditions or have particular equipment or logistics needs. System 10 may present the tailored asset information via browser 100.

Browser 100 may include options for viewing information related to available asset packages. For example, browser 100 may include information for viewing mechanical drives information 102, including different types of mechanical drives available to a particular customer or machinery provider. Browser 100 may also provide information on compressor sets 104, which may include a plurality of available compressor sets. Browser 100 may further include information regarding available generator sets 106, as well as gearbox and/or pump packages (not shown).

Browser 100 may also include information related to logistics 108. Available logistics information 108 may include, for example, information associated with the types of vehicles available at a particular worksite and/or their capabilities. Logistics information 108 may also incorporate the number and types of machines or equipment available at a particular worksite, and a number of employees on site at a given time. For example, in the logistic information box 108 of browser 100, four types of equipment are shown as being available at one selected site, including ships, helicopters, cargo trucks, and airplanes. Similarly, logistics information may also include a number of employees available at that site or the number of employees required at that site in order to perform a particular task.

Browser 100 may also provide information regarding platforms 110 that are available to a user. This list of available platforms may be accessed by clicking or selecting the items in section 110 and may be tailored to a user's particular equipment needs. For example, if a user is involved in a particular sea-based project, sample platforms section 110 may include Platforms A, B, C, and D, as well as vessel FPSO, Semi submersible, and TLP. Alternatively, the user may select to view an operation involving land and sea. In this case, section 110 may provide off-shore platforms and land-based buildings, such as warehouses. It is also contemplated that user equipment information in sample platform information 110 may be obtained or modified according to prior or related projects involving a particular customer.

Exemplary browser 100 may further include information related to asset criticality 112. A user or customer may assign a level of criticality to, for example, each platform selected from sample platform information 110, based on the contribution that the particular asset or package of assets makes to the overall production and operation. As mentioned above, asset criticality information 112 may be graphically represented as a particular color, such as red, yellow, or green, indicative of the asset criticality. Asset criticality information 112 may also provide a default criticality rating without an associated color.

Exemplary browser 110 may also include background information 136 related to the geographic characteristics of a particular operation. For example, background information 136 may include a simulated environment including representations of land, sea, cities, or any combination thereof. Background information 136 may recreate particular characteristics relevant to sea operations, such as maritime depth. Background information 136 may also recreate geographic characteristics relevant to land-based operations, such as terrain elevation and availability of airports or roads.

Background information 136 may also provide a distance scale. Available distance information may allow a customer or user to, for example, evaluate the distance between assets. This distance information may allow a user or customer to evaluate the amount of time required to complete a particular operation, such as travel between assets.

Background information 136 may allow a user to visualize a particular operation. For example, background information 136 may include a representation of a particular project. A user or customer may populate background information 136 by clicking, selecting, and dragging icons from mechanical drives information 102, compressor sets information 104, generator sets information 104, logistics information 108, and platform information 110. The graphical representation of a land and sea-based operation may include a display of one or more vessels 114 and 116. Background information may also be populated with icons representing off-shore platforms (shown as 118, 120, and 122). Vessels 114 and 116, as well as off-shore platforms 118, 120, and 122 may be associated with logistics equipment 124, 126 and 128. Logistics equipment 124, 126 and 128 may include helicopters and/or vessels. The logistics information may indicate transportation needs between the assets populated in the background information 136, according to a user's particular needs.

Background information 136 may also include, as part of a land-sea project, land-based structures such as heliport 130 and warehouse 132. Heliport 130 and warehouse 132 may also be associated with logistics equipment, such as helicopter 128 and vehicle 134. Land-based structures 130 and 132 may also be associated with sea-based logistics equipment 124 and 126, as well as with vessels 114 and/or 116, and off-shore platforms 118, 120, and/or 122.

Browser 100 may include multimedia controls. For example, browser 100 may include a section for selecting audio to be played during the planning session (not shown). The audio selected may include spoken instructions on how to operate browser 100. Browser 100 may further include a section providing a user with the alternative of saving the particular selections, such as the populated background information (section 138) during execution or upon completion. Browser 100 may further provide controls for selecting (section 140) a zoom of the background display information 136. Browser 100 may further provide (section 142) an option for switching among various projects made available by the asset criticality tool or previously prepared by the user.

It is further contemplated that system 10 may obtain user project information from sources other than database 18, which may be either public or private. This information may be obtained in order to develop, deliver, and/or execute asset criticality and planning content tailored to a user's particular needs. Examples of user or project information obtained from other databases include geographic location, type of industry (e.g., oil, gas, and/or maintenance), budget, and number of employees.

Although the disclosed implementation may include a particular network configuration, embodiments of the present disclosure may be implemented in a variety of data communication network environments using software, hardware, or a combination of hardware and software to provide the processing functions. Those skilled in the art will appreciate that all or part of systems and methods consistent with the present disclosure may be stored on or read from other computer-readable media. System 10 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 10, such as, for example, computing platform 16, database 18, memory 20, processor 22, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The information packages, performance estimates and results, or asset information obtained from the asset criticality system for the user's reference may include paper documents, electronic documents, Internet-based documents, and any other suitable media for documentation. The packages may include electronic documents, such as computer files. Such files may be provided to members of the target population or customers via various modes of transmission, such as email. Internet-based documents may include word processor type files and/or webpages, which may include the asset criticality-related information, estimates, and/or reports. Administration of such documents may include notifying members in any suitable way of the availability and/or accessibility of such documents, including updated to existing content, and may provide an Internet address for accessing the documents.

Implementation of the disclosed system may be, to some extent, undertaken by hand. For example, the determination of which information will be administered to individual users of the target population and/or the assembly of reports may be handled by one or more persons, e.g., representatives, managers or administrators of the machinery providing entity. It is contemplated, however, that either a manual, semi-computerized, or fully computerized implementation may be utilized.

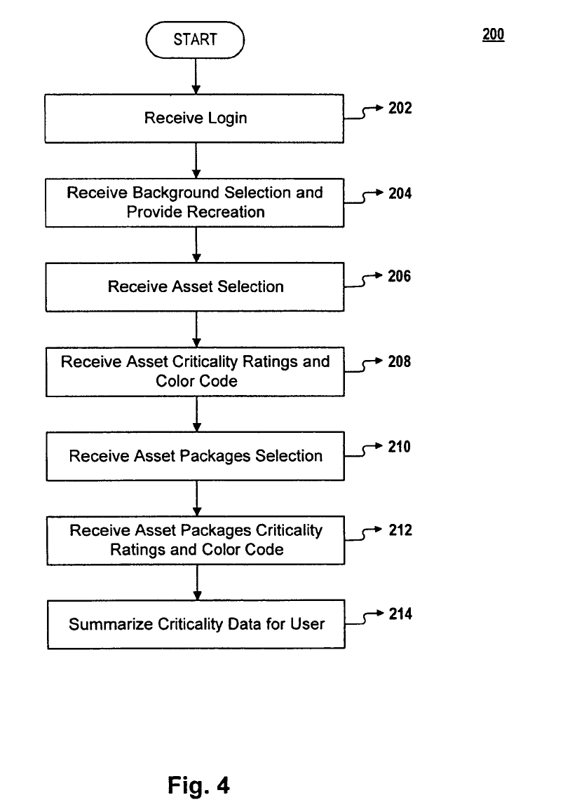

FIG. 4 illustrates a flowchart 200 depicting an exemplary method that utilizes asset criticality system 10 to provide assistance to a user during the planning process, including visualization of a particular project. The method depicted in flowchart 200 will be described in more detail below.

### INDUSTRIAL APPLICABILITY

The disclosed method and system may provide a tool that allows customers or machinery providers to assess the criticality of industrial assets in a particular operation. In particular, the disclosed method and system may assist in the planning stage of a project, based on a user's particular machinery and equipment needs. In this manner, a current or prospective customer who is in the planning stage of a project may be provided with electronic visualization that captures existing and available equipment, its criticality and operating context, as well as the related logistic support strategies and procedures. The user of the disclosed asset criticality tool may then make an informed decision when planning, selecting, changing, or modifying the assets implemented in a particular project.

As illustrated in FIG. 4, the first step in the functioning of the asset criticality system 10 may include receiving a log-in from a user (Step 202). The log-in procedure may be completed via input module 12, including input device 28. During log-in, a user may also enter information related to particular business aspects, such as, for example, type of project, company or prior business relationship with the machinery provider.

Upon receipt and verification of log-in information, asset criticality system 10 may be initialized. Initialization may include an asset criticality system receiving from a user a selection of background information, which may then be graphically recreated for the user (Step 204). Initialization may be used to tailor visualization of a planning project to the equipment needs of a particular user. For example, the particular background information may be used to recreate particular geographic characteristics of a desired work site, such as, for example, geographic characteristics of land and sea environments, or combinations thereof. It is also contemplated that the created background information may recreate geographic characteristics of urban areas, if desired.

Asset criticality system 10 may then provide with a list of available assets to the user and receive from the user a selection (Step 206). The list of assets may include, for example, off-shore platforms, vessels, land-based operations, and buildings. The user may choose the assets by individually clicking, selecting, and dragging the corresponding icons into the asset criticality background. The user may be given the alternative to position the selected asset in a desired location relative to other assets or to a particular geographic characteristic, such as a coast or a mountain. For example, a user may position a particular off-shore oil drilling platform 4 miles west of a land-based heliport. Similarly, a user may be interested in locating several off-shore platforms within a given distance from one another.

If the user desires to incorporate only certain types of assets contained within the tool, such as, for example, sea-based assets, the asset criticality system 10 may then provide background information relating to only sea-based operations. For example, if a user selects to populate background information utilizing sea-based assets, the asset criticality system 10 may provide a work site representation only allowing a customer or user to evaluate the distance between the sea-based assets. The user may be provided with the alternative to label the assets or edit the labels provided by the asset criticality system 10.

As part of the method, asset criticality system 10 may receive from the user asset criticality ratings, associated with a corresponding color code (Step 208). For example, the user may have populated the created or selected background with a combination of assets. The combination of assets selected by the user may include a type “A” platform, labeled as “Complex B” and a type “D” platform, labeled as “Complex A.” The user may consider “Complex A” as an asset with low production volume or with full redundant capacity. Unplanned downtime associated with “Complex A” may cause few adverse effects. Thus, the user may rate “Complex A” as having low criticality. The asset criticality system 10 may highlight the icon representing “Complex A” and change its color to green.

In the same example, the user may consider, however, that “Complex B” is of the highest importance. Downtime associated with “Complex B” may cause significant impact to production. No redundant equipment may be available for “Complex B.” Thus, the user may rate “Complex B” as having high criticality. The asset criticality system 10 may then highlight the icon representing “Complex B” and change its color to red.

The user may have also included two “FPSO” type vessels during completion of Step 208. The user may have rated one of the vessels as having high criticality, while the second may have been rated a having medium criticality. The asset criticality system 10 may then provide a red color for the first vessel and may color the second vessel yellow.

The user may have further included a “TLP” type platform, located, closer to the shore, according to the user's particular needs. This platform may have been assigned a medium criticality rate by the user. The “TLP” platform may then appear as yellow in the background provided by the asset criticality system 10.

As part of Step 208, the user may also be provided the opportunity to assign a default criticality to a selected asset. The default criticality may be automatically assigned by the asset criticality system or may be particular to an individual customer or project, determined based on previous planning scenarios. The user may also be provided the opportunity of removing an asset previously added to the background.

The user may then be provided with the alternative to select asset packages, including, for example, engine, gearbox, generator, compressor, or pump packages. This selection may then be received by the asset criticality system 10 (Step 210). This information may be obtained from the mechanical drive, compressor set, and generator set information provided in the asset criticality browser. The user may populate the various assets with packages by clicking, selecting, and dragging the corresponding icons representing the packages into the appropriate asset.

For example, a user may desire to associate three “T130” mechanical drives and one “T130” compressor set with the “FPSO” vessel previously rated with high criticality. The user may additionally associate one “M90” compressor set, one “T70” generator set, and one “T60” compressor set with “Complex A,” previously designated by the user as having low criticality. The user may also associate one or several packages with each one of the assets previously populated into the asset criticality background.

The user may then rate by criticality each one of packages associated with the populated assets. This criticality rating, along with its corresponding color code may then be received by the asset criticality system 10 (Step 212). For example, a user may have previously associated three “T130” mechanical drives and one “T1 30” compressor set with the “FPSO” vessel rated with high criticality. The user may then designate two of the “T130” mechanical drives as having high criticality. The user may also designate a low criticality to the third “T130” mechanical drive, and rate the “T130” compressor set as having medium criticality.

The user may additionally and individually rate each of the packages added to the assets previously populated into the asset criticality background. The user may also be provided the opportunity to add notes associated with each asset. These notes may, for example, indicate actions that a particular customer may desire to take in the future. In the process of rating the packages populated into “Complex A,” the user may choose to indicate that the customer desires or needs an upgrade for the “M90” mechanical drive in the next year. The notes may also indicate particular functions associated with the asset. For example, the user may indicate in the notes that the “T70” generator set package associated with “Complex A” powers motor driven water injection pumps.

The asset criticality system 10 may then summarize the information provided by the user, including asset and package criticality (Step 214). The asset criticality system 10 may summarize the customer's capabilities in combination with the provider's capabilities in terms of people, processes, and technology. For example, the provided criticality information may be summarized along with location data of supply chain, dealers, site level assessment, and ability to handle service calls. The activity may be utilized in determining the scope of a project. For example, a user may utilize the provided information when considering the support required for the selected assets and packages.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims.

What is claimed is:

1. A computer-readable medium, tangibly embodied, including instructions for:
receiving project information from a user;
receiving asset population information about a project;
determining a plurality of available assets according to the received information;
generating asset information for the user based on the determined plurality available assets;
providing at least one customized background display based on the received project and asset population information and generated asset information;
enabling the user to populate the customized background display by selectively adding individual assets; and
enabling the user to individually rate the populated assets according to their criticality.

2. The computer-readable medium of claim 1, wherein the received project information includes specified location types, including at least one of a land-based and an off-shore operation.

3. The computer-readable medium of claim 1, wherein the generated asset information includes information relating to at least one of an off-shore platform, a vessel, and a building.

4. The computer-readable medium of claim 1, further including instructions for enabling the user to populate the customized background with packages of assets.

5. The computer-readable medium of claim 4, wherein the packages of assets include at least one of an engine package, a gearbox package, a generator package, a compressor package, and a pump package.

6. The computer-readable medium of claim 5, further including instructions for receiving information from the user regarding criticality of the asset packages.

7. The computer-readable medium of claim 6, further including instructions for summarizing the criticality information.

8. A method for assessing the criticality of an asset, comprising:
receiving project information from a user;
receiving asset population information about a project;
determining a plurality of available assets according to the received information;
generating asset information for the user based on the determined plurality of available assets; and
providing at least one customized background display based on the received project and asset population information and generated asset information;
enabling the user to populate the customized background display by selectively adding assets; and
enabling the user to individually rate the populated assets according to their criticality.

9. The method of claim 8, wherein the received project information includes specified location types, including at least one of land-based and an off-shore operation.

10. The method of claim 8, wherein the generated asset information includes information relating to at least one of an off-shore platform, a vessels, and a building.

11. The method of claim 8, further including enabling the user to populate the customized background with packages of assets.

12. The method of claim 11, wherein the packages include at least one of an engine package, a gearbox package, a generator package, a compressor package, and a pump package.

13. The method of claim 12, further including receiving information from the user regarding criticality of the asset packages.

14. The method of claim 13, further including instructions for summarizing the criticality information.

15. A computer system, comprising:
a platform;
at least one input device; and
a central processing unit in communication with the platform and the at least one input device, the central processing unit configured to:
receive project information about a user;
receive asset population information about a project;
determine a plurality of available assets according to the received information;
generate asset information for the user based on the determined plurality of available assets;
provide at least one customized background display based on the received project and asset population information and generated asset information;
enable the user to populate the customized background display by selectively adding individual assets; and
enable the user to individually rate the populated assets according to their criticality.

16. The computer system of claim 15, wherein the generated asset information includes information relating to at least one of an off-shore platform, a vessel, and a building.

17. The computer system of claim 15, wherein the central processing unit is further configured to enable the user to populate the customized background with packages of assets.

18. The computer system of claim 17, wherein the packages include at least one of an engine package, a gearbox package, a generator package, a compressor package, and a pump package.

19. The computer system of claim 18, wherein the central processing unit is further configured to receive information from the user regarding criticality of the asset packages.

20. The computer system of claim 19, wherein the central processing unit is further configured to:
summarize the criticality information.
